(19) United States
(12) Patent Application Publication
(10) Pub. No.: US 2016/0016262 A1
(43) Pub. Date: Jan. 21, 2016

(54) LASER WELDING PROCESS

(71) Applicant: MIDWAY PRODUCTS GROUP, INC., Monroe, MI (US)

(72) Inventor: PERIKLES TSIPIS, LASALLE, MI (US)

(21) Appl. No.: 14/802,263

(22) Filed: Jul. 17, 2015

Related U.S. Application Data
(60) Provisional application No. 62/025,812, filed on Jul. 17, 2014.

(51) Int. Cl. B23K 26/32; B23K 26/08

(52) U.S. Cl. CPC B23K 26/3206; B23K 26/0869

(57) ABSTRACT

A laser welding process for welding together metal sheets. For example, this process could be used to weld together dual-phase steel sheets, such as DP980 steel. A laser welding machine with selectable amplitude and pitch values is provided. The laser beam is moved along a sinusoidal path at the welding site to weld together sheets.

### RELATED APPLICATION

The present application is related to and claims priority to U.S. Provisional Patent Application Ser. No. 62/025,812, filed on Jul. 17, 2014, entitled “Laser Welding Process.” The subject matter disclosed in that provisional application is hereby expressly incorporated into the present application in its entirety.

### TECHNICAL FIELD

This disclosure relates generally to laser welding metal sheets together; in particular, this disclosure relates to a laser welding process for welding together dual-phase steel sheets.

### BACKGROUND AND SUMMARY

In the automotive industry, there have been substantial development efforts to create materials that make vehicles lighter and stronger while also being safer and more fuel-efficient. In part due to these efforts, there are many different types and strengths of steel which are tailored to handle stresses associated with both normal driving conditions and crashes. One type of steel that is now being used in vehicles is called dual-phase steel, which has certain desirable strength and other characteristics. Although this type of steel has desirable qualities, welding together sheets of this steel can be challenging. For example, it can be difficult to achieve a desired S-value, which is the width of the weld at the interface of the joined sheets, coupled with a sufficient depth of penetration. Accordingly, there is a need for a novel welding process that can overcome these difficulties.

This disclosure provides a laser welding process for welding together metal sheets. According to one illustrative embodiment, the process uses a laser welding machine with selectable amplitude and pitch values. The laser welding machine includes a controllable laser beam aligned with a welding site on a work piece. To weld together the metal sheets, the laser beam is moved along a sinusoidal path at the welding site. This allows the sheets to be joined together with a desirable S-value and depth of penetration.

Additional features and advantages of the invention will become apparent to those skilled in the art upon consideration of the following detailed description of the illustrated embodiment exemplifying the best mode of carrying out the invention as presently perceived. It is intended that all such additional features and advantages be included within this description and be within the scope of the invention.

### BRIEF DESCRIPTION OF THE DRAWINGS

The present disclosure will be described hereafter with reference to the attached drawings which are given as non-limiting examples only, in which:

FIG. 1 is a side cross-sectional view of example metal sheets that have been welded together according to an embodiment of this disclosure;

FIG. 2 is an example sinusoidal path of the laser welding device according to an embodiment of this disclosure;

FIG. 3 is a side cross-sectional view of metal sheets that have been welded together according to an embodiment of this disclosure;

FIG. 4 is a table showing test data for various welding techniques that failed to weld together DP980 steel and achieve the desired specifications for depth of penetration and S-dimension, except for Samples 17a and 17b, which were welded according to an embodiment of this disclosure;

FIGS. 5A and 5B are tables showing test data for sample pieces of DP980 steel that were welded together to successfully achieve depth of penetration and S-dimension values using a welding technique according to an embodiment of this disclosure.

Corresponding reference characters indicate corresponding parts throughout the several views. The components in the figures are not necessarily to scale, emphasis instead being placed upon illustrating the principals of the invention. The exemplification set out herein illustrates embodiments of the invention, and such exemplification is not to be construed as limiting the scope of the invention in any manner.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the disclosure.

This disclosure relates to a laser welding process for welding together two sheets of metal. This process is particularly advantageous for dual-phase steel sheets, such as DP980.

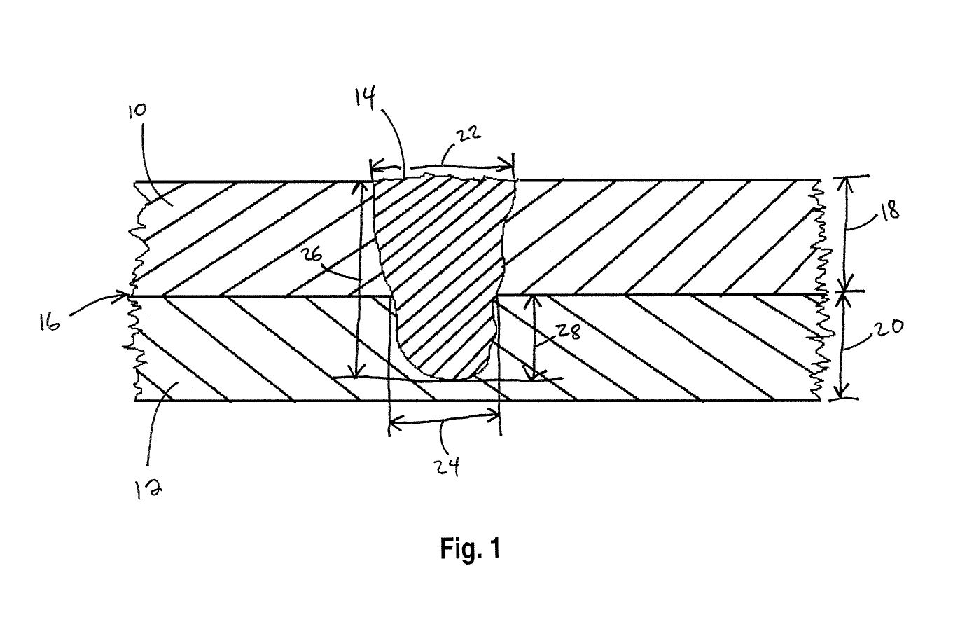

FIG. 1 is a side cross-sectional view of an example weld between two metal sheets. In this example, the first sheet 10 is welded to a second sheet 12 using a weld 14. The weld 14 secures together the first sheet 10 and the second sheet 12 by having the weld extend through the first sheet 10 and penetrate the second sheet 12. This means that the weld penetrates entirely through the thickness 18 of the first sheet 10, but only partially through the thickness 20 of the second sheet 12. The depth of penetration 28 is the amount of the weld's 14 penetration into the second sheet 12. The S-dimension 28 is the width of the weld 14 at the interface 16 between the sheets 10, 12 being joined. The face dimension is the width of the weld at the end of the first sheet 10 opposite the interface 16. The throat value is the entire depth of the weld 14 in both the first sheet 10 and second sheet 12.

In one embodiment, this laser welding process is configured to weld together 2 mm thick sheets of DP980 steel with a desired S-dimension of at least 1.8 mm (e.g., 90% of the thinnest material in the stack) and a minimum depth of penetration that is 30% of the thickness of the bottom sheet (i.e., minimum of 0.6 mm with 2 mm bottom sheet). In one embodiment, this process uses an 8 kW fiber laser welding power source from IPG Photonics Corporation of Oxford, Mass. with a HighYag remote laser welding head—RLSK from HighYag Lasertechnologie GmbH of Stahnsdorf, Germany and a 300 micron fiber cable. One skilled in the art should appreciate that other wattage of lasers and other configurations could be used depending on the circumstances.

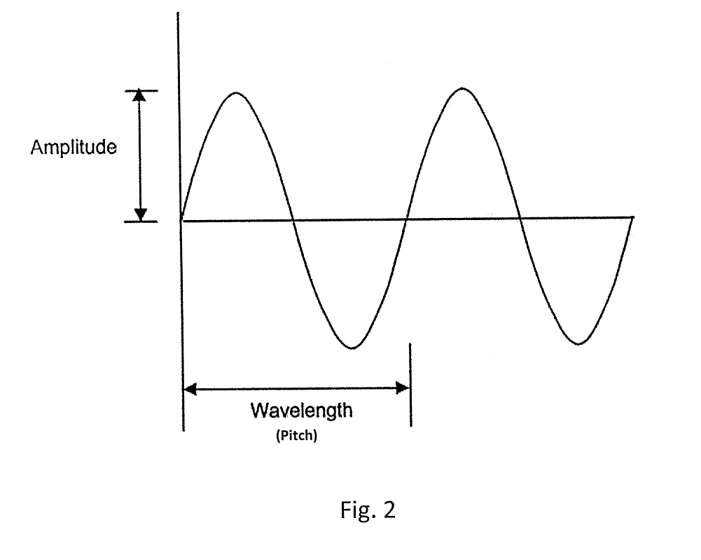

FIG. 2 shows the sinusoidal path of the laser beam along the welding site. The wavelength and amplitude of the sinusoidal path will differ depending on the circumstances. However, if the laser welding process is configured to weld together 2 mm thick sheets of DP980 steel with a desired S-dimension of at least 1.8 mm (e.g., 90% of the thinnest material in the stack) and a minimum depth of penetration that is 30% of the thickness of the bottom sheet (i.e., minimum of 1.4 mm with 2 mm bottom sheet), the amplitude should be between 1.65 mm and 1.85 mm and the pitch should be between 0.9 mm and 1.1 mm. The speed at which the laser beam moves along the welding path is a factor in the depth of penetration and would be between 5 m/min and 10 m/min, but will fluctuate per gaps in the materials.

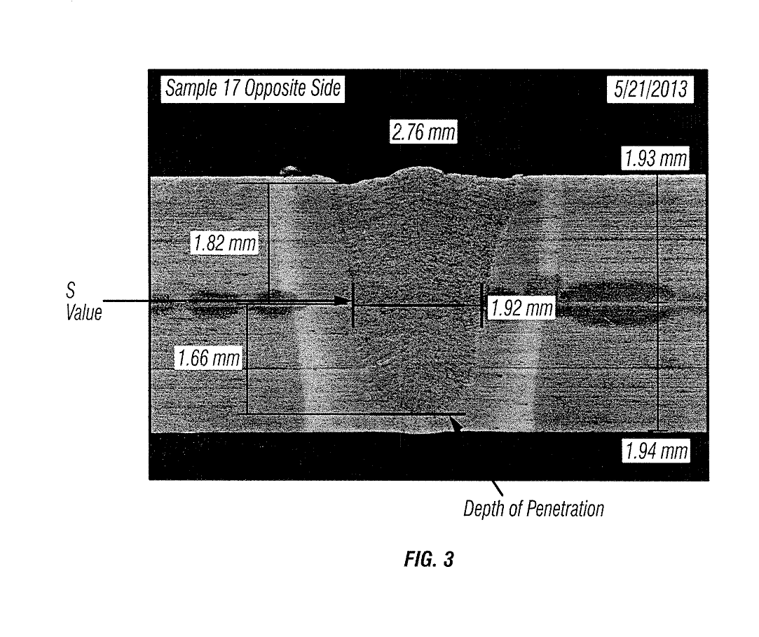

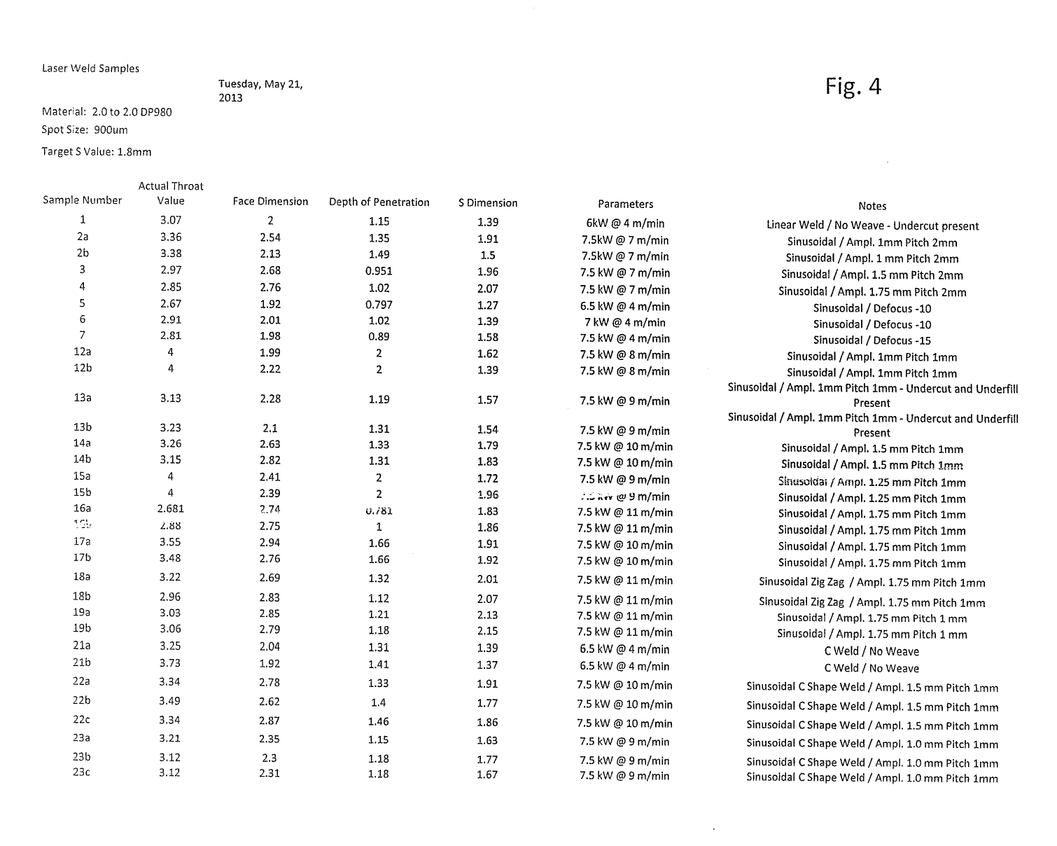

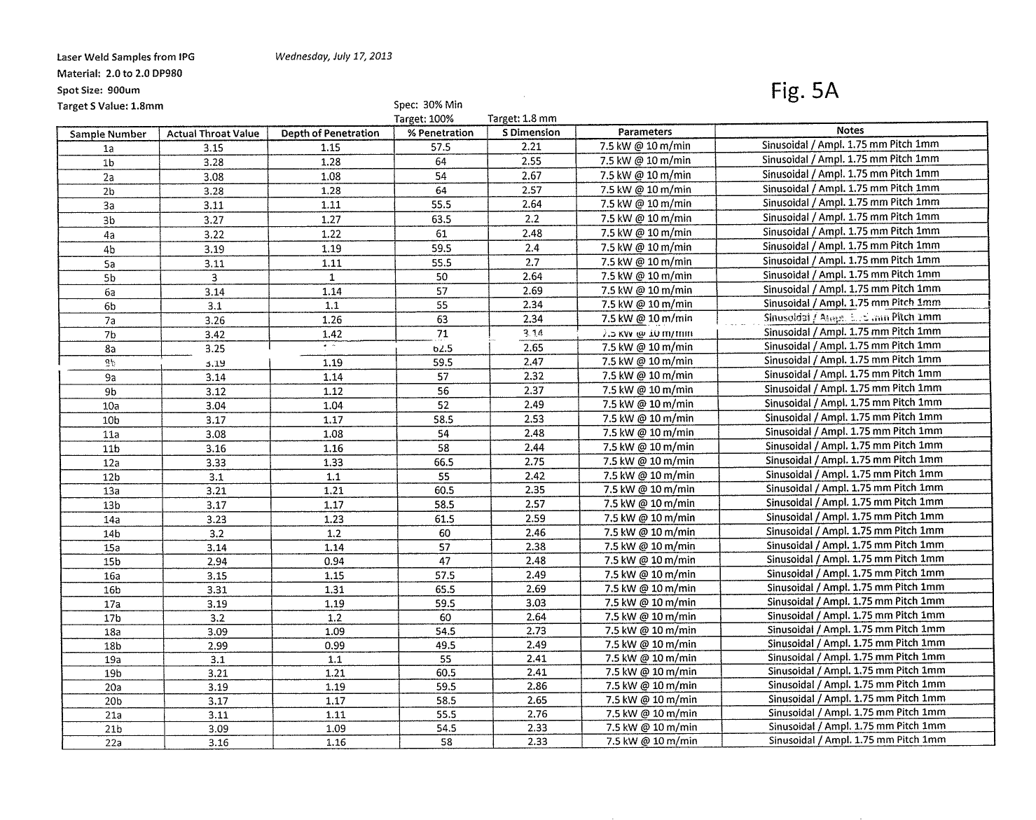

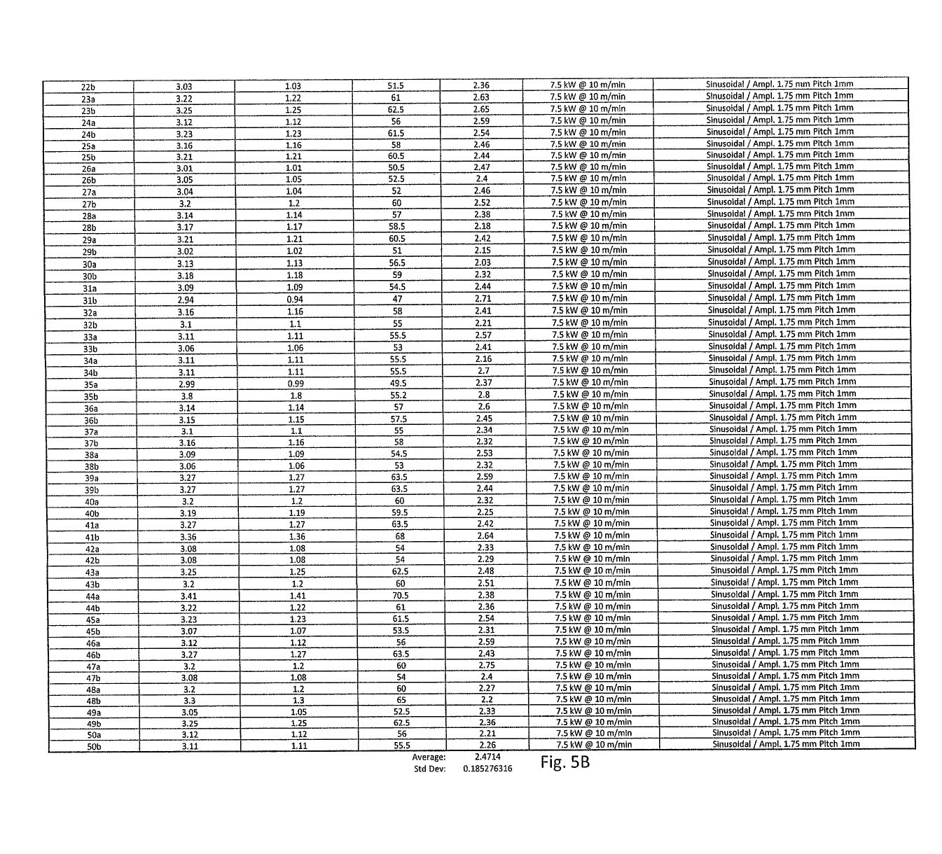

FIG. 3 shows an example cross-sectional view of a weld between two 2 mm thick sheets of DP980 steel. This corresponds with sample 17b in FIG. 4. As can be seen, the S-dimension is 1.92 mm while the depth of penetration is 1.66 mm, which satisfies the requirements mentioned above. FIG. 4 lists several different welding techniques that were tried to achieve the desired S-dimension and depth of penetration. The only samples that met the desired S-dimension and depth of penetration are Samples 17a and 17b in which a sinusoidal path has an amplitude of 1.75 mm, a pitch of 1 mm, and a speed of 10 m/min. None of the other techniques for welding the pieces together were able to achieve the desired S-dimension and depth of penetration as shown. However, one skilled in the art should appreciate that the amplitude, pitch, and speed will vary depending on the thickness of the sheets being welded and other materials properties. FIGS. 5A-5B show test data on various samples showing that the depth of penetration and S-dimension satisfied the desired specification.

Illustrative examples of the laser welding process disclosed herein are provided below. An embodiment of the technologies may include any one or more, and any combination of, the examples described below.

Example 1 includes a laser welding process in which a first sheet and a second sheet of dual phase steel are provided. A laser welding machine is provided with a selectable amplitude and a selectable pitch. The laser welding machine includes a controllable laser beam aligned with a welding site on the first sheet. The laser beam is moved along a sinusoidal path at the welding site to create a weld between the first sheet and the second sheet. The weld joins together the first sheet and the second sheet by having the weld extend completely through the first sheet and partially penetrate into the second sheet.

Example 2 includes the subject matter of Example 1, and wherein a width of the weld at an interface between the first sheet and the second sheet is at least 90% of a thickness of either the first sheet or the second sheet whichever is the thinnest.

Example 3 includes the subject matter of Example 1, and wherein a depth of penetration of the weld into the second sheet is at least 30% of a thickness of the second sheet.

Example 4 includes the subject matter of Example 1, and wherein the laser welding machine is set with an amplitude of the sinusoidal path selected in the range between approximately 1.65 mm and 1.85 mm.

Example 5 includes the subject matter of Example 4, and wherein the laser welding machine is set with the pitch selected in the range between approximately 0.9 and 1.1 mm.

Example 6 includes the subject matter of Example 5, and wherein the first sheet and the second sheet have a thickness of approximately 2 mm.

Example 7 includes the subject matter of Example 1, and wherein the laser welding machine has an 8 kW fiber laser welding power source.

Example 8 includes the subject matter of Example 1, and wherein the laser welding machine includes an approximately 300 micron fiber cable.

Example 9 includes the subject matter of Example 1, and wherein the first sheet and the second sheet are formed from DP980 steel.

Example 10 includes a laser welding process in which a first sheet and a second sheet of steel are provided. A laser welding machine is provided with a selectable amplitude and a selectable pitch. The laser welding machine includes a controllable laser beam aligned with a welding site on the first sheet. The laser beam is moved along a sinusoidal path at the welding site to create a weld between the first sheet and the second sheet. The weld joins together the first sheet and the second sheet by having the weld extend completely through the first sheet and partially penetrate into the second sheet. The depth of penetration of the weld into the second sheet is at least 30% of a thickness of the second sheet. The width of the weld at an interface between the first sheet and the second sheet is at least 90% of a thickness of either the first sheet or the second sheet whichever is the thinnest.

Example 11 includes the subject matter of Example 10, and wherein the laser welding machine is set with an amplitude of the sinusoidal path selected in the range between approximately 1.65 mm and 1.85 mm.

Example 12 includes the subject matter of Example 11, and wherein the laser welding machine is set with the pitch selected in the range between approximately 0.9 and 1.1 mm.

Example 13 includes the subject matter of Example 12, and wherein the first sheet and the second sheet have a thickness of approximately 2 mm.

Example 14 includes the subject matter of Example 13, and wherein the laser welding machine has an 8 kW fiber laser welding power source.

Example 15 includes the subject matter of Example 14, and wherein the laser welding machine includes an approximately 300 micron fiber cable.

Example 16 includes the subject matter of Example 15, and wherein the first sheet and the second sheet are formed from dual phase steel.

Example 17 includes the subject matter of Example 16, and wherein the first sheet and the second sheet are formed from DP980 steel.

Example 18 includes a laser welding process in which a laser welding machine is provided with a selectable amplitude and a selectable pitch. The laser welding machine includes a controllable laser beam aligned with a welding site on a work piece. The laser beam is moved along a sinusoidal path at the welding site. The laser welding machine is set with the amplitude of the sinusoidal path selected in the range between approximately 1.65 mm and 1.85 mm. The laser welding machine is set with the pitch selected in the range between approximately 0.9 and 1.1 mm.

Example 19 includes the subject matter of Example 18, and wherein the laser welding machine has an 8 kW fiber laser welding power source.

Example 20 includes the subject matter of Example 19, and wherein the laser welding machine includes an approximately 300 micron fiber cable.

Although the present disclosure has been described with reference to particular means, materials, and embodiments, from the foregoing description, one skilled in the art can easily ascertain the essential characteristics of the invention and various changes and modifications may be made to adapt the various uses and characteristics without departing from the spirit and scope of the invention.

What is claimed is:

1. A laser welding process comprising the steps of:
providing a first sheet of dual phase steel;
providing a second sheet of dual phase steel;
providing a laser welding machine with a selectable amplitude and a selectable pitch, wherein the laser welding machine includes a controllable laser beam aligned with a welding site on the first sheet; and
moving the laser beam along a sinusoidal path at the welding site to create a weld between the first sheet and the second sheet, wherein the weld joins together the first sheet and the second sheet by having the weld extend completely through the first sheet and partially penetrate into the second sheet.

2. The laser welding process as recited in claim 1, wherein a width of the weld at an interface between the first sheet and the second sheet is at least 90% of a thickness of either the first sheet or the second sheet whichever is the thinnest.

3. The laser welding process as recited in claim 2, wherein a depth of penetration of the weld into the second sheet is at least 30% of a thickness of the second sheet.

4. The laser welding process as recited in claim 1, wherein the laser welding machine is set with an amplitude of the sinusoidal path selected in the range between approximately 1.65 mm and 1.85 mm.

5. The laser welding process as recited in claim 4, wherein the laser welding machine is set with the pitch selected in the range between approximately 0.9 and 1.1 mm.

6. The laser welding process as recited in claim 5, wherein the first sheet and the second sheet have a thickness of approximately 2 mm.

7. The laser welding process as recited in claim 1, wherein the laser welding machine has an 8 kW fiber laser welding power source.

8. The laser welding process as recited in claim 1, wherein the laser welding machine includes an approximately 300 micron fiber cable.

9. The laser welding process as recited in claim 1, wherein the first sheet and the second sheet are formed from DP980 steel.

10. A laser welding process comprising the steps of:
providing a first sheet of steel;
providing a second sheet of steel;
providing a laser welding machine with a selectable amplitude and a selectable pitch, wherein the laser welding machine includes a controllable laser beam aligned with a welding site on the first sheet;
moving the laser beam along a sinusoidal path at the welding site to create a weld between the first sheet and the second sheet, wherein the weld joins together the first sheet and the second sheet by having the weld extend completely through the first sheet and partially penetrate into the second sheet;
wherein a depth of penetration of the weld into the second sheet is at least 30% of a thickness of the second sheet; and
wherein a width of the weld at an interface between the first sheet and the second sheet is at least 90% of a thickness of either the first sheet or the second sheet whichever is the thinnest.

11. The laser welding process as recited in claim 10, wherein the laser welding machine is set with an amplitude of the sinusoidal path selected in the range between approximately 1.65 mm and 1.85 mm.

12. The laser welding process as recited in claim 11, wherein the laser welding machine is set with the pitch selected in the range between approximately 0.9 and 1.1 mm.

13. The laser welding process as recited in claim 12, wherein the first sheet and the second sheet have a thickness of approximately 2 mm.

14. The laser welding process as recited in claim 13, wherein the laser welding machine has an 8 kW fiber laser welding power source.

15. The laser welding process as recited in claim 14, wherein the laser welding machine includes an approximately 300 micron fiber cable.

16. The laser welding process as recited in claim 16, wherein the first sheet and the second sheet are formed from dual phase steel.

17. The laser welding process as recited in claim 16, wherein the first sheet and the second sheet are formed from DP980 steel.

18. A laser welding process comprising the steps of:
providing a laser welding machine with a selectable amplitude and a selectable pitch, wherein the laser welding machine includes a controllable laser beam aligned with a welding site on a work piece;
moving the laser beam along a sinusoidal path at the welding site;
wherein the laser welding machine is set with the amplitude of sinusoidal path selected in the range between approximately 1.65 mm and 1.85 mm; and
wherein the laser welding machine is set with the pitch selected in the range between approximately 0.9 and 1.1 mm.

19. The laser welding process as recited in claim 18, wherein the laser welding machine has an 8 kW fiber laser welding power source.

20. The laser welding process as recited in claim 18, wherein the laser welding machine includes an approximately 300 micron fiber cable.
